(19) United States
(12) Patent Application Publication
(10) Pub. No.: US 2010/0315342 A1
(43) Pub. Date: Dec. 16, 2010

(54) MOUSE APPARATUS

(75) Inventor: Yuhei AKATSUKA, Nagano (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Sony Corporation, Tokyo (JP)

(21) Appl. No.: 12/794,099

(22) Filed: Jun. 4, 2010

(30) Foreign Application Priority Data
Jun. 15, 2009 (JP) 2009-142815

(51) Int. Cl. G06F 3/033

(52) U.S. Cl. 345/163

(57) ABSTRACT

A mouse apparatus includes a mouse body, at least one operation portion, a slide cover, and a switch portion. The mouse body includes a built-in battery. The operation portion is provided on the mouse body. The slide cover is movable with respect to the mouse body between a first position that disables an operation by blocking the operation portion and a second position that enables an operation to be made by exposing the operation portion. The switch portion turns off power supply from the battery when the slide cover is at the first position and turns on the power supply from the battery when the slide cover is at least at the second position.

### BACKGROUND OF THE INVENTION

1. Field of the Invention

The present invention relates to a mouse apparatus, more particularly, to a mouse apparatus that includes a built-in battery and performs wireless communication with an apparatus to be operated.

2. Description of the Related Art

Mouse apparatuses are widely used as input apparatuses for various information processing apparatuses such as a personal computer and a game apparatus. Moreover, in recent years, mouse apparatuses that perform wireless communication instead of performing wired communication as a host apparatus have appeared, and this type of mouse apparatuses obtain operational power from a built-in battery. Therefore, wireless mouse apparatuses adopt a unique structure that is not adopted in wired mouse apparatuses.

One feature of the unique structure is an operation portion for turning the power on/off. A manual switch is generally used for turning the power of the mouse apparatus on/off (see, for example, Japanese Patent Application Laid-open No. 2005-107703).

However, when a manual switch is adopted, the switch may be pressed by an external pressure and the power may be turned on without a user noticing it while the mouse apparatus is being carried by the user, thus resulting in wasteful consumption of a built-in battery and causing a situation where the mouse apparatus is out of battery when the user tries to use it. In this regard, a mechanism that is capable of preventing an unintended power-on/off operation from being made and also preventing an unintended input operation from being made at a time the mouse apparatus is carried around is demanded.

### SUMMARY OF THE INVENTION

However, there is still room for improvement in the mouse apparatuses of the related art for preventing the battery from being wastefully consumed due to users' carelessness in forgetting to turn off the power. For example, in a case of a mouse apparatus in which a power-on/off state can be checked based on a position of an end portion of a power supply switch provided on a side surface of a mouse body, a user needs to consciously check the position of the end portion of the power supply switch, which is insufficient for effectively preventing a user from forgetting to turn off the power. In addition, when functions of operation portions including left and right buttons and a scroll wheel are to be changed in the mouse apparatus depending on an application, it is generally the case that a mode switch button is newly added to the mouse body. As a result, the number of exposed buttons increases, an interface structure becomes complex, and a size of the mouse body is enlarged.

In view of the circumstances as described above, there is a need for a compact mouse apparatus with which more-intuitive power-switch operations can be made and that has a favorable operability and portability.

According to an embodiment of the present invention, there is provided a mouse apparatus including a mouse body, at least one operation portion, a slide cover, and a switch portion. The mouse body includes a built-in battery. The operation portion is provided on the mouse body. The slide cover is movable with respect to the mouse body between a first position that disables an operation by blocking the operation portion and a second position that enables an operation to be made by exposing the operation portion. The switch portion turns off power supply from the battery when the slide cover is at the first position and turns on the power supply from the battery when the slide cover is at least at the second position.

In the embodiment of the present invention, power can be turned on/off in an interlocking manner with a movement of the slide cover, with the result that more-intuitive power-switch operations become possible.

Further, in the embodiment of the present invention, a surface of the mouse body opposed to the slide cover is a curvature radius surface that sticks out upwardly, and the slide cover is constituted of a plate having a shape that is curved along the curvature radius surface of the mouse body.

With this structure, the slide cover can be moved along the curvature radius, and a improvement in operability can thus be expected.

Moreover, in the embodiment of the present invention, the slide cover may include a cover body, a cover base portion, and an attachment portion. The cover base portion is movably provided on the mouse body. The attachment portion is fixed to the cover base portion and detachably attaches the cover body. In this case, the attachment portion may include a positioning portion that positions, while securing a certain amount of a relief portion in a first axis direction in which the slide cover is movable, the cover body in a second axis direction orthogonal to the first axis direction, and the cover base portion may include a fixing portion that fixes the cover body positioned at one end portion of the relief portion secured by the positioning portion of the attachment portion.

With this structure, the slide cover can be positively attached and detached with ease.

Moreover, according to the embodiment of the present invention, the mouse apparatus may further include a bias means. The bias means biases, when the slide cover is within a first range between a first intermediate position, that is a predetermined position between the first position and the second position, and the first position, the slide cover from the first intermediate position toward the first position, and biases, when the slide cover is within a second range between the first intermediate position and the second position, the slide cover from the first intermediate position toward the second position.

With this structure, since the slide cover is moved from the first intermediate position toward the first position or the second position by a bias force of the bias means once the slide cover is intentionally moved to the first intermediate position, a human load for operating the slide cover can be reduced.

Further, in the embodiment of the present invention, the switch portion may turn on the power supply from the battery when the slide cover is within a range from the second position to a second intermediate position that is a predetermined position between the first position and the second position, and the mouse apparatus may further include a mode switch portion to switch an input mode at a time the slide cover is at the second position and a time the slide cover is at the second intermediate position.

With this structure, an input mode of a button of the mouse apparatus can be switched based on the position of the slide cover.

Furthermore, according to the embodiment of the present invention, the mouse apparatus may further include a mode display portion to display a result of the switch of the input mode. With this structure, a user can easily check an operation mode of the mouse apparatus while using the mouse apparatus.

According to the embodiment of the present invention, since a power-switch operation can be performed more intuitively, it is possible to prevent a user from forgetting to turn off the power, and an additional size reduction and improvements in an operability and portability can be realized.

These and other objects, features and advantages of the present invention will become more apparent in light of the following detailed description of best mode embodiments thereof, as illustrated in the accompanying drawings.

### BRIEF DESCRIPTION OF DRAWINGS

FIG. 1 is an outer perspective view of a mouse apparatus according to an embodiment of the present invention;

FIG. 2 is an outer perspective view of the mouse apparatus in a state where a slide cover is positioned at one end of a movable range;

FIG. 3 is an exploded perspective view showing a structure of a mouse body;

FIG. 4 is an exploded perspective view of the slide cover;

FIG. 5 is an enlarged diagram of an engagement groove;

FIG. 6 is a plan view of a back surface of a cover body;

FIG. 7 are plan views showing positional relationships among respective portions at a time the cover body is positioned at two different positions with respect to a cover base portion and an attachment portion;

FIG. 8 are an enlarged plan view and an enlarged cross-sectional side view each showing a structure of a fixing mechanism;

FIG. 9 is a plan view showing a state where the slide cover is positioned at a first position;

FIG. 10 is a plan view showing a state where the slide cover is positioned at an intermediate position between the first position and a second position;

FIG. 11 is a plan view showing a state where the slide cover is positioned at the second position;

FIG. 12 is a block diagram showing an electrical structure of the mouse apparatus;

FIG. 13 is a side view showing a coupled state of the slide cover and the base portion;

FIG. 14 is a partially-enlarged cross-sectional diagram of FIG. 13;

FIG. 15 is a perspective view showing a lower casing of the mouse apparatus according to the embodiment of the present invention;

FIG. 16 is a diagram showing a relationship between the position of the slide cover and a state of switches;

FIG. 17 is a diagram showing a relationship between the position of the slide cover and the state of switches;

FIG. 18 is a diagram showing a relationship between the position of the slide cover and the state of switches;

FIG. 19 is a block diagram showing an electrical structure of the mouse apparatus;

FIG. 20 is a flowchart showing a flow of processing of a CPU that is started when power of the mouse apparatus is turned on;

FIG. 21 is a flowchart showing a flow of processing of the CPU that is carried out when the slide cover is slid in a y0 direction from the second position;

FIG. 22 is an upper plan view of a mouse apparatus according to Modified Example 1.

FIG. 23 are diagrams showing designs of a cover body of a mouse apparatus according to Modified Example 2; and

FIG. 24 is a perspective view showing a mouse apparatus according to Modified Example 3.

### DESCRIPTION OF PREFERRED EMBODIMENTS

Hereinafter, embodiments of the present invention will be described with reference to the drawings.

### First Embodiment

### Overall Structure

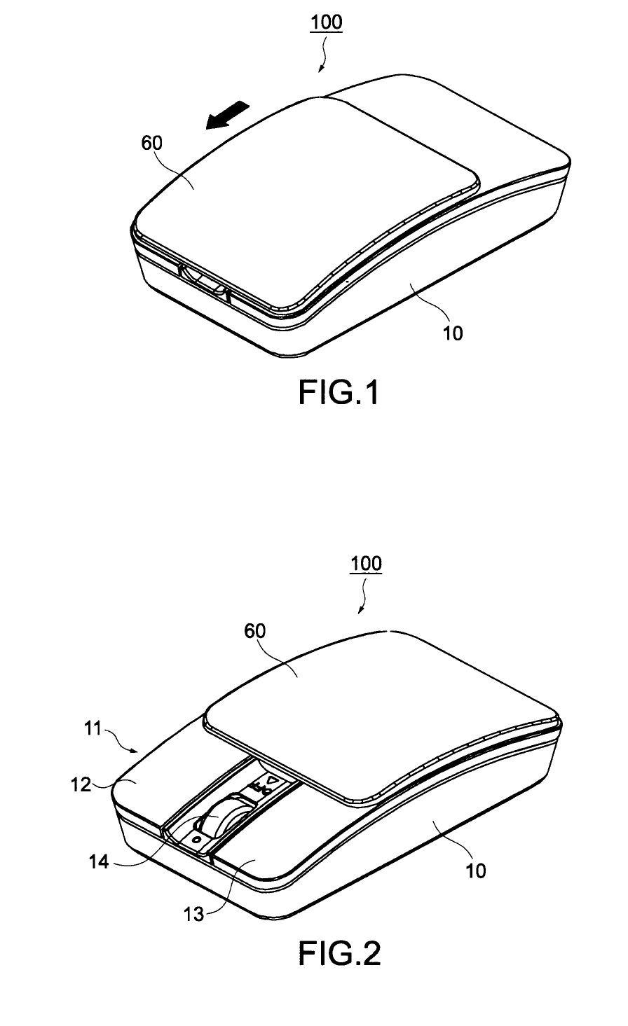

FIG. 1 is an outer perspective view of a mouse apparatus according to an embodiment of the present invention.

A mouse apparatus 100 has an appropriate size and outer shape to fit in a palm of a user to be used. Regarding an appearance, the mouse apparatus 100 includes a mouse body 10 that almost constitutes an entire outer shape and a slide cover 60 that is provided on a surface of the mouse body 10 on a side on which the palm of the user is placed.

The surface of the mouse body 10 on the side on which the palm of the user is placed is a curvature radius surface that sticks out upwardly in a Y-Z cross section. The slide cover 60 is constituted of a plate that is curved along the curvature radius surface of the mouse body 10 and is movable in a Y-axis direction along the curvature radius surface. It should be noted that FIG. 1 is an outer perspective view showing a state where the slide cover 60 is at one end of a movable range in the Y-axis direction (hereinafter, referred to as “first position”).

On the contrary, FIG. 2 is an outer perspective view of the mouse apparatus in a state where the slide cover 60 is positioned at the other end of the movable range (hereinafter, referred to as “second position”). As shown in the figure, a key portion 11 provided on the mouse body 10 is exposed when the slide cover 60 is positioned at the second position. As a result, the key portion 11 can be operated with a finger of a user holding the mouse apparatus 100. In other words, the key portion 11 is covered by the slide cover 60 when the slide cover 60 is at the first position and can be operated for the first time when the slide cover 60 is moved to the second position or approximately the second position. The key portion 11 is constituted of, for example, a right button 12, a left button 13, and a scroll wheel 14 provided between those buttons.

(Structure of Mouse Body 10)

Next, a structure of the mouse body 10 will be described.

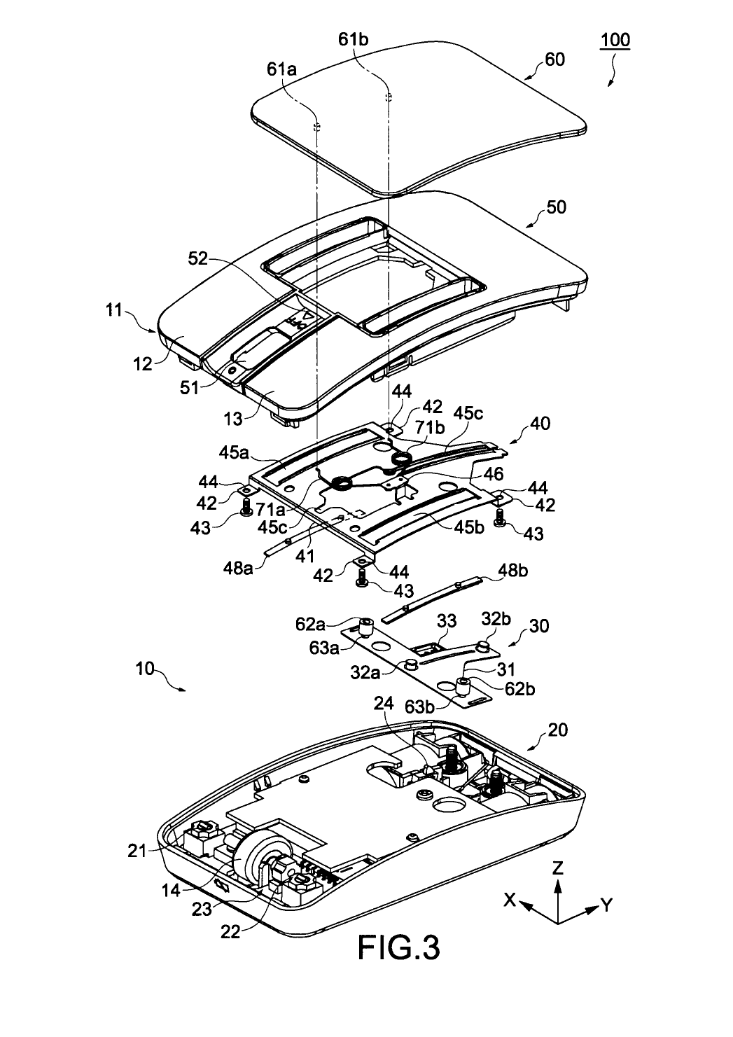

FIG. 3 is an exploded perspective view showing the structure of the mouse body 10.

As shown in the figure, the mouse body 10 is constituted of a lower casing 20, a base portion 30, a rail portion 40, an upper casing 50, and the like. Here, the lower casing 20 and the upper casing 50 are formed of a synthetic resin and the like, and the base portion 30 and the rail portion 40 are formed of metal.

Incorporated into the lower casing 20 are, as components necessary for structuring the mouse apparatus 100, a right-button switch 21, a left-button switch 22, a scroll-wheel assembly 23, and a cover-opening/closing operation detection switch 24, for example. Though not shown in FIG. 3, a wheel-press detection switch, a main print substrate, an optical system assembly, a battery, and the like are also incorporated into the lower casing 20.

The right-button switch 21 is a switch that detects a press of the right button 12 of the key portion 11. The left-button switch 22 is a switch that detects a press of the left button 13 of the key portion 11. The scroll-wheel assembly 23 rotatably holds the scroll wheel 14 and detects a rotational amount, rotational speed, rotational direction, and the like of the scroll wheel 14. The cover-opening/closing operation detection switch 24 is a switch that detects that the slide cover 60 has moved to the second position at which the key portion 11 can be operated. Those components are provided on the main print substrate (not shown).

In addition to the components described above, a CPU that performs overall control of the mouse apparatus 100, the optical system assembly, a battery portion, a wireless module, and the like are also mounted on the main print substrate (not shown). The wireless module performs processing for establishing wireless communication with an information processing apparatus such as a PC (Personal Computer). The optical system assembly is means for detecting a position of the mouse apparatus 100 and generating information on two-dimensional coordinates.

The descriptions above have been made on the lower casing 20.

The rail portion 40 includes a rail portion body 41 and a plurality of fixing portions 42 for fixing the rail portion body 41 to the upper casing 50 using screws 43. In other words, fixing screw holes 44 through which the screws 43 are fixed to the upper casing 50 are formed on the plurality of fixing portions 42. On the other hand, on a lower surface of the upper casing 50 opposed to the rail portion 40, a plurality of boss portions (not shown) that include screw holes respectively corresponding to the fixing screw holes 44 of the fixing portions 42 are formed.

Moreover, a first guide groove 45a, a second guide groove 45b, and a third guide groove 45c that guide a movement of the base portion 30 in the Y-axis direction are formed on the rail portion body 41. The first guide groove 45a and the second guide groove 45b out of the first to third guide grooves 45a to 45c are provided at both end portions of the rail portion body 41 in an X-axis direction, and the remaining third guide groove 45c is provided at substantially the center of the rail portion 40 in the X-axis direction. Coupling shafts 62a and 62b that are each formed of a resin and supported between the base portion 30 and the slide cover 60 at both end portions thereof respectively engage with the first guide groove 45a and the second guide groove 45b. Specifically, the coupling shafts 62a and 62b and the first and second guide grooves 45a and 45b are engaged such that circumferential surfaces of the coupling shafts 62a and 62b are brought into contact with inner walls of the first and second guide grooves 45a and 45b, respectively. Moreover, two engagement pins 32a and 32b that protrude from a base portion body 31 of the base portion 30 in a Z-axis direction and are provided apart from each other in the Y-axis direction are inserted into the third guide groove 45c. Furthermore, thin-plate-like resin components 48a and 48b for an insulation from the base portion 30 are fixed at both end portions of a surface of the rail portion body 41 in the X-axis direction on a side opposed to the base portion 30.

A spring support portion 46 is also provided on the rail portion body 41. The spring support portion 46 is erected from the rail portion body 41 in the Z-axis direction toward the upper casing 50 and bent in an L shape. One end of each of inverted springs 71a and 71b is fixed to the spring support portion 46. Other ends of the inverted springs 71a and 71b are respectively fixed to spring support portions 61a and 61b formed on a back surface of the slide cover 60. The inverted springs 71a and 71b are spiral coil springs in which spirals are wound along an X-Y plane. The inverted springs 71a and 71b as described above contribute to thinning of an apparatus. A direction of a bias force of the inverted springs 71a and 71b is switched at an intermediate position of a movable range of the slide cover 60 in the Y-axis direction using a change of a positional relationship between support points that is due to the movement of the slide cover 60 in the Y-axis direction.

Next, a structure of the base portion 30 will be described.

The base portion 30 is interposed between the lower casing 20 and the rail portion 40. The base portion 30 is coupled to the slide cover 60 via the coupling shafts 62a and 62b. With this structure, the base portion 30 and the slide cover 60 move integrally in the Y-axis direction. As described above, the coupling shafts 62a and 62b respectively engage with the first guide groove 45a and the second guide groove 45b of the rail portion 40. Moreover, the two engagement pins 32a and 32b that engage with the third guide groove 45c of the rail portion 40 are also provided on the base portion 30. By the engagement relationship described above, the base portion 30 integrally moves with the slide cover 60 in the Y-axis direction with respect to the rail portion 40.

Further, a switch operation protrusion 33 that is formed of a resin and presses the cover-opening/closing operation detection switch 24 provided on the lower casing 20 is fixed to the base portion body 31. The switch operation protrusion 33 presses the cover-opening/closing operation detection switch 24 when the slide cover 60 is moved to the second position so as to expose the key portion 11 provided on the mouse body 10 and switches a state of the switch 24 from a first state to a second state. It should be noted that the switch 24 constantly receives a bias force in a direction opposite to the direction in which the switch 24 is pressed by the switch operation protrusion 33 by means of a spring or the like and is thus kept in the first state when not pressed by the switch operation protrusion 33.

Next, a structure of the upper casing 50 will be described.

The upper casing 50 is an upper casing of the mouse body 10, and an upper surface thereof is a predetermined curvature radius surface that sticks out upwardly in a Y-Z cross section. Moreover, the key portion 11, an opening 51 from which the scroll wheel 14 is exposed, and the like are provided on the upper casing 50. On the back surface of the upper casing 50, a plurality of fixing portions (not shown) for fixing the rail portion 40 using the screws 43 are provided.

(Structure of Detachable Slide Cover 60)

Next, a structure of the slide cover 60 will be described.

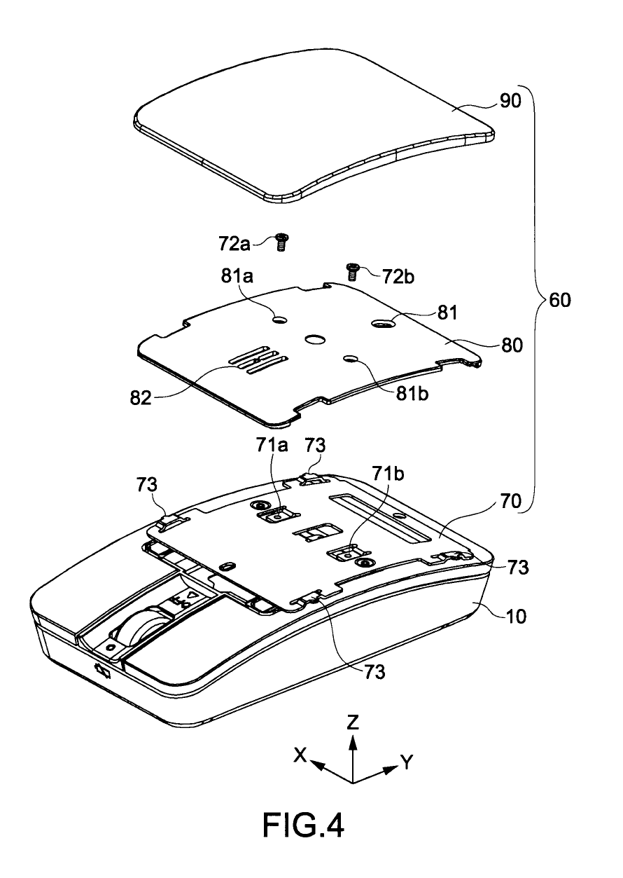

FIG. 4 is an exploded perspective view of the slide cover 60.

As shown in the figure, the slide cover 60 has a three-layer structure including a cover base portion 70, an attachment portion 80, and a cover body 90 that are all formed of metal.

The cover base portion 70 is coupled with the base portion body 31 of the base portion 30 via screws 63a and 63b on a back surface thereof. On the back surface of the cover base portion 70, the spring support portions 61a and 61b (FIG. 3) for fixing the other ends of the inverted springs 71a and 71b (corresponding to bias means) whose one end is fixed to the spring support portion 46 of the rail portion body 41 are provided. The cover base portion 70 is placed on top of the upper casing 50 of the mouse body 10 with a slight gap provided therebetween.

On the cover base portion 70, a plurality of screw holes 71A and 71B for fixing the attachment portion 80 using screws 72a and 72b are provided. At both end portions of the cover base portion 70 in the X-axis direction, a plurality of claws 73 (corresponding to fixing portion) that respectively latch, from the Z-axis direction, a plurality of hooks 93 formed at both end portions of the cover body 90 in the X-axis direction are provided.

The attachment portion 80 is placed on top of the cover base portion 70 and fixed thereto by the plurality of screws 72a and 72b respectively inserted into a plurality of screw holes 81a and 81b.

Also on the attachment portion 80, an engagement hole 81 and an engagement groove 82 (corresponding to positioning portion) for positioning the cover body 90 are provided.

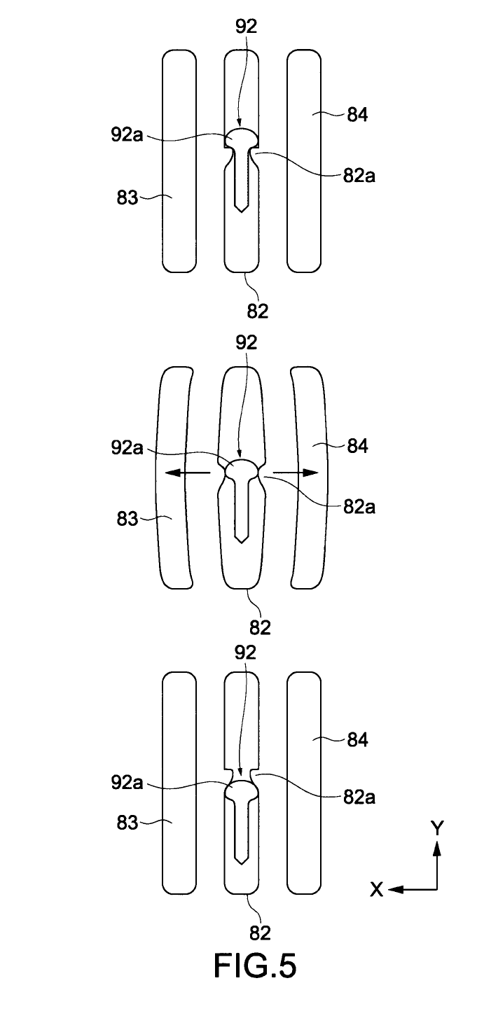

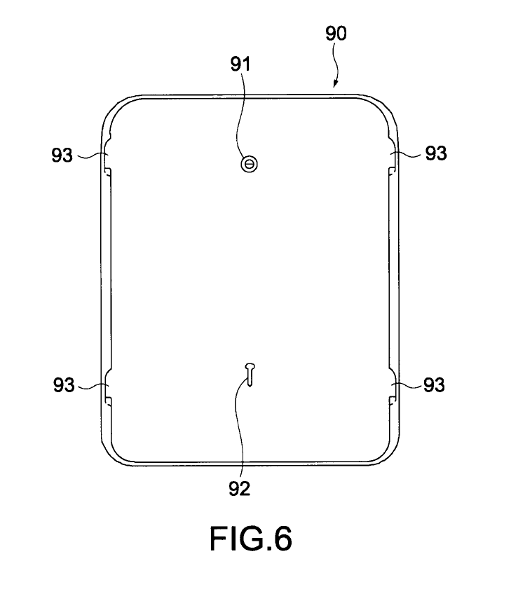

FIG. 5 is an enlarged diagram of the engagement groove 82, and FIG. 6 is a plan view of the back surface of the cover body 90.

The engagement hole 81 is a hole elongated in the Y-axis direction. An engagement pin 91 that protrudes from the back surface of the cover body 90 is inserted into the engagement hole 81 in the Z-axis direction and engages therewith. On the other hand, an engagement protrusion 92 that protrudes from the back surface of the cover body 90 is inserted in to the engagement groove 82 in the Z-axis direction and engages therewith. The engagement groove 82 is a hole elongated in the Y-axis direction. In the engagement groove 82, a narrow portion 82a for imparting an adequate resistive operational feeling to a user at a time the cover body 90 is attached to or detached from the attachment portion 80 and restraining the cover body 90 from being detached from the attachment portion 80 is provided. By narrowing a groove width of the engagement groove 82 to be smaller than a diameter of a columnar portion 92a of the engagement protrusion 92, the narrow portion 82a restricts a free movement of the engagement protrusion 92. In other words, unless a force that is equal to or larger than a restriction force caused by the narrow portion 82a is applied by the user, the cover body 90 cannot be detached from the attachment portion 80.

Further, in the vicinity of both sides of the engagement groove 82 of the attachment portion 80 in the X-axis direction, adjustment grooves 83 and 84 for controlling a movement restriction force caused by the narrow portion 82a are formed in parallel with the engagement groove 82. By the adjustment grooves 83 and 84, plate material portions of the attachment portion 80 that remain among the adjustment grooves 83 and 84 and the engagement groove 82 can be easily made a spring structure capable of being elastically deformed in the X-axis direction within a range of an intentionally-applied force. As a result, an effect that a degree of freedom in selecting a material and plate thickness of the attachment portion 80 increases can be obtained.

With this structure, the cover body 90 becomes movable in the Y-axis direction with respect to the cover base portion 70 and the attachment portion 80 between the two positions.

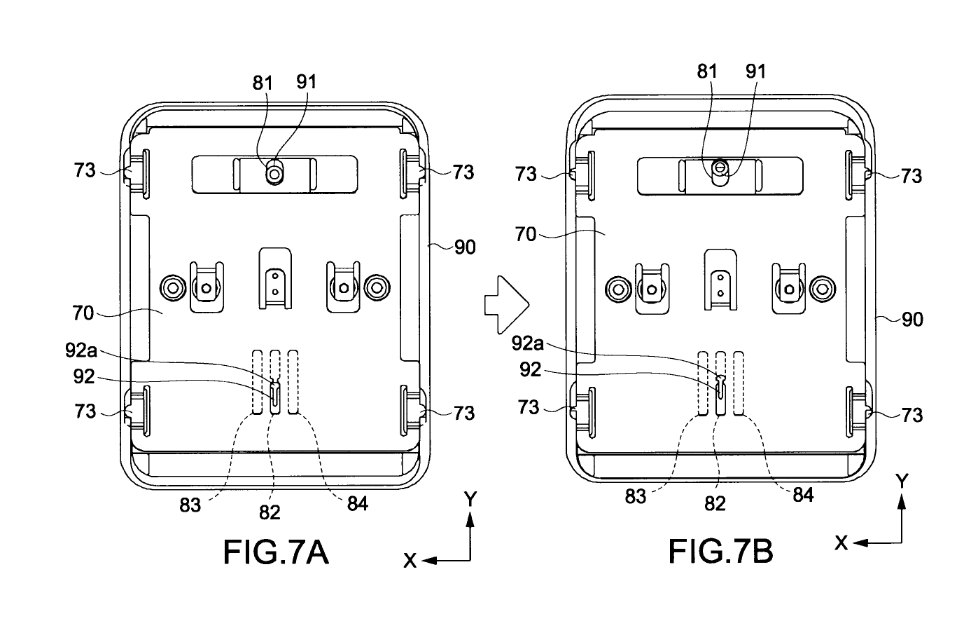

FIG. 7 are plan views showing positional relationships among the respective portions at a time the cover body 90 is positioned at two different positions with respect to the cover base portion 70 and the attachment portion 80. Here, FIG. 7A is a diagram showing a state where the cover body 90 is at a position at which it can be detached from the cover base portion 70 and the attachment portion 80, and FIG. 7B is a diagram showing a state where the cover body 90 is at a position at which it is fixed to the cover base portion 70 and the attachment portion 80 by a fixing mechanism to be described later.

When the cover body 90 is at the position shown in FIG. 7A at which it can be detached from the cover base portion 70 and the attachment portion 80, the engagement pin 91 of the cover body 90 is at one end of the engagement hole 81 of the attachment portion 80 (lower end in FIG. 7). On the other hand, the columnar portion 92a of the engagement protrusion 92 of the cover body 90 is positioned on one side of the engagement groove 82 seen from the narrow portion 82a (lower end in FIG. 7). Further, when the cover body 90 is at the position shown in FIG. 7B at which it is fixed to the cover base portion 70 and the attachment portion 80, the engagement pin 91 of the cover body 90 is at the other end of the engagement hole 81 of the attachment portion 80 (upper end in FIG. 7). On the other hand, the columnar portion 92a of the engagement protrusion 92 of the cover body 90 is positioned on the other side of the engagement groove 82 seen from the narrow portion 82a (upper end in FIG. 7).

Next, a mechanism for fixing the cover body 90 to the cover base portion 70 and the attachment portion 80 in the mouse apparatus 100 will be described.

The fixing mechanism is constituted of the plurality of claws 73 formed at both end portions of the cover base portion 70 in the X-axis direction and the plurality of hooks 93 formed at both end portions of the cover body 90 in the X-axis direction.

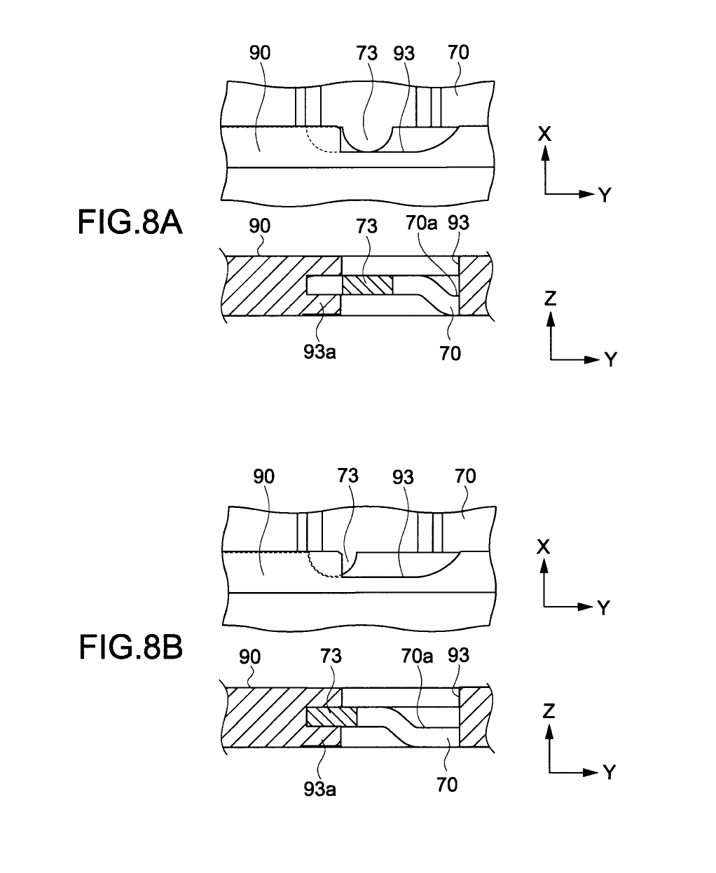

FIG. 8 are an enlarged plan view and an enlarged cross-sectional side view each showing a structure of the fixing mechanism. Here, FIG. 8A shows a state where the cover body 90 can be detached from the cover base portion 70 and the attachment portion 80, and FIG. 8B shows a state where the cover body 90 is fixed to the cover base portion 70 and the attachment portion 80.

As shown in the figures, the claws 73 of the cover base portion 70 protrude from both ends of the cover base portion 70 in the X-axis direction and slightly float from a main surface 70a of the cover base portion 70. On the other hand, the hooks 93 of the cover body 90 also protrude from both ends of the cover body 90 in the X-axis direction so as to be aligned with the claws 73 formed on the cover base portion 70. One end portion of the hook 93 in the Y-axis direction is formed in a hook shape and functions as a claw holding portion 93a that holds the claw 73 from both sides in the Z-axis direction.

Specifically, since the claw 73 is not held by the claw holding portion 93a of the hook 93 in FIG. 8A, the cover body 90 can be detached from the cover base portion 70 and the attachment portion 80. When the cover body 90 is moved uniaxially in the Y-axis direction with respect to the cover base portion 70 and the attachment portion 80 from this state, the claw 73 goes into the claw holding portion 93a of the hook 93 to be eventually held by the claw holding portion 93a. As a result, the cover body 90 is pressed by the cover base portion 70 and the attachment portion 80 from both sides in the Z-axis direction and fixed thereto. For releasing the fixed state, the cover body 90 only needs to be moved in a direction opposite to the fixing direction with respect to the cover base portion 70 and the attachment portion 80.

(Opening/Closing Operation of Slide Cover 60)

Next, an opening/closing operation of the slide cover 60 will be described.

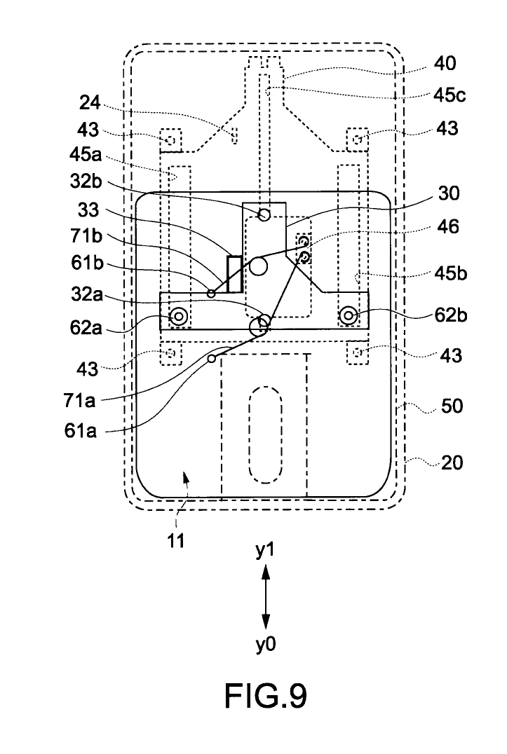

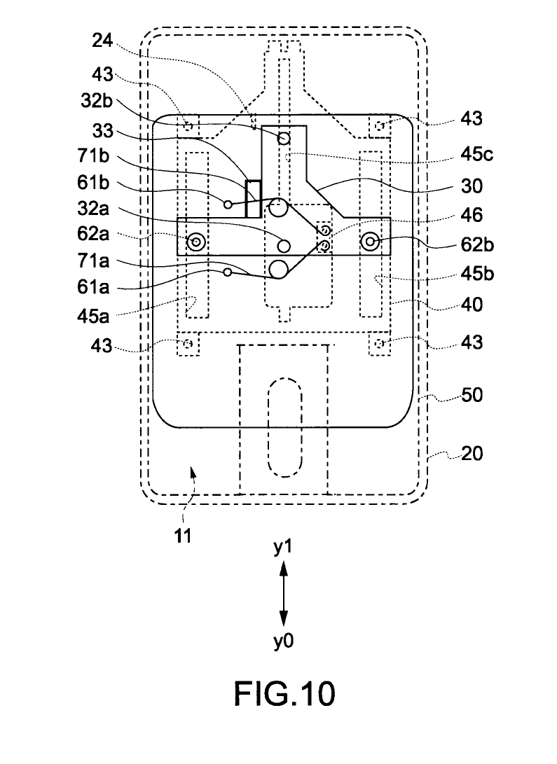

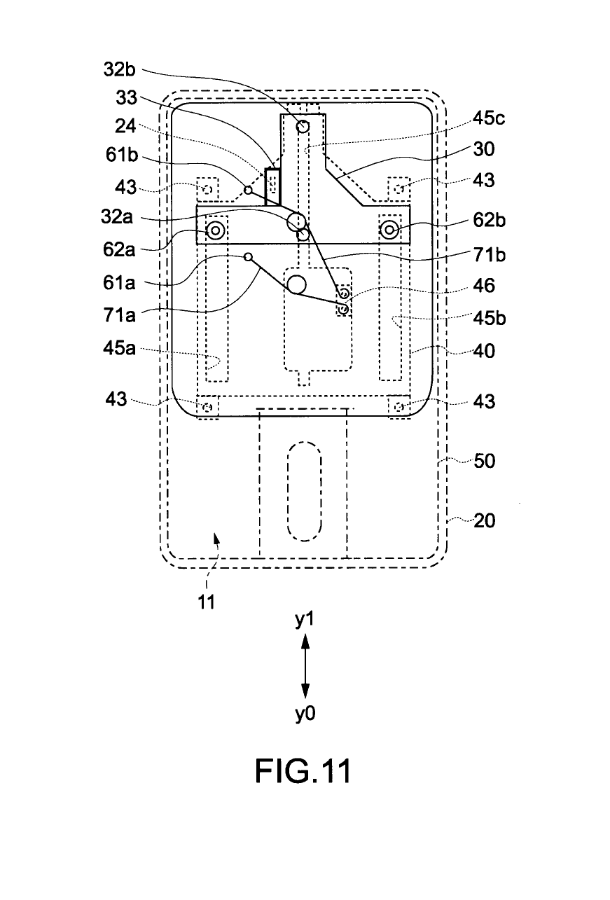

FIG. 9 is a plan view showing a state where the slide cover 60 is positioned at the first position. FIG. 11 is a plan view showing a state where the slide cover 60 is positioned at the second position. FIG. 10 is a plan view showing a state where the slide cover 60 is positioned at an intermediate position between the first position and the second position. Here, the intermediate position between the first position and the second position may be an intermediate position strictly set based on a distance, or may be a position arbitrarily set between the first position and the second position. Hereinafter, those positions will collectively be referred to as intermediate position. Moreover, in FIGS. 9 to 11, the upper casing 50, the rail portion 40, and the like that do not move with respect to the lower casing 20 at a time the slide cover 60 is slid are indicated by dashed lines or dotted lines, whereas the base portion 30 and the slide cover 60 that move with respect to the lower casing 20 at the time the slide cover 60 is slid are indicated by solid lines.

When a user applies a force to move the slide cover 60 in a y1 direction by an operation with a finger in the state shown in FIG. 9, the slide cover 60 and the base portion 30 move integrally from the first position toward the intermediate position. When the slide cover 60 is within a first range between the first position and the intermediate position, the inverted springs 71a and 71b bias the slide cover 60 from the intermediate position toward the first position. Therefore, when the slide cover 60 slides in the y1 direction from the first position to the intermediate position, the slide cover 60 slides against the force of the inverted springs 71a and 71b. At this time, the coupling shafts 62a and 62b and the engagement pin 32b are guided in the y1 direction by the first guide groove 45a, the second guide groove 45b, and the third guide groove 45c, respectively.

When the slide cover 60 is positioned at the intermediate position shown in FIG. 10, forces of the inverted springs 71a and 71b are balanced, with the result that a force for biasing a slide of the slide cover 60 is hardly generated.

Furthermore, when a user applies a force to move the slide cover 60 in the y1 direction, the slide cover 60 and the base portion 30 integrally slide from the intermediate position to the second position. At this time, the coupling shafts 62a and 62b and the engagement pin 32b are guided in the y1 direction by the first guide groove 45a, the second guide groove 45b, and the third guide groove 45c, respectively.

When the slide cover 60 is positioned at the second position, the coupling shafts 62a and 62b and the engagement pin 32b are positioned at ends of the first guide groove 45a, the second guide groove 45b, and the third guide groove 45c, respectively, as shown in FIG. 11. As described above, a sliding length of the slide cover 60 is restricted based on the lengths of the first guide groove 45a, the second guide groove 45b, and the third guide groove 45c.

When the slide cover 60 is within a second range between the intermediate position and the second position, the inverted springs 71a and 71b bias the slide cover 60 to move from the intermediate position toward the second position. As a result, the slide cover 60 slides naturally from the intermediate position to the second position.

In midst of the slide of the slide cover 60 in the second range, the switch operation protrusion 33 provided on the base portion 30 is brought into contact with the cover-opening/closing operation detection switch 24 and presses it (FIG. 11). As a result, power of the mouse apparatus 100 is turned on.

In contrast, when the slide cover 60 slides from the second position toward the intermediate position, the switch operation protrusion 33 is released from the cover-opening/closing operation detection switch 24, and the state of the switch 24 returns to an unpressed state. As a result, power of the mouse apparatus 100 is turned off.

Moreover, when the slide cover 60 slides from the intermediate position to the first position, the inverted springs 71a and 71b bias the slide cover 60 from the intermediate position toward the first position. As a result, the slide cover 60 slides naturally from the intermediate position to the first position.

As described above, in the mouse apparatus 100, if the user intentionally slides the slide cover 60 from one end of the movable range to approximately the intermediate position, the slide cover 60 slides naturally in a direction intended by the user the rest of the way by an operation of the inverted springs 71a and 71b. As a result, an operability of the slide cover 60 is improved.

(Electrical Structure)

Next, an electrical structure of the mouse apparatus 100 will be described.

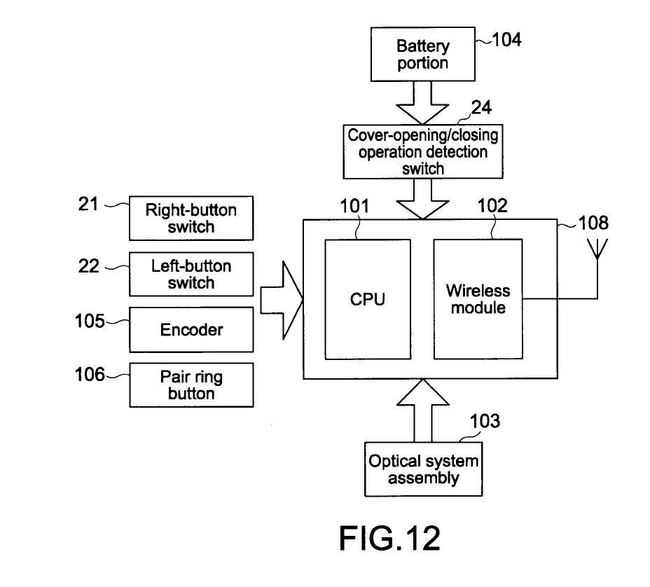

FIG. 12 is a block diagram showing the electrical structure of the mouse apparatus 100.

As shown in the figure, the mouse apparatus 100 includes, as the electrical structure, a CPU (Central Processing Unit) 101, a wireless module 102, an optical system assembly 103, a battery portion 104, the cover-opening/closing operation detection switch 24, the right-button switch 21, the left-button switch 22, an encoder 105, and a pair ring button 106. The CPU 101 and the wireless module 102 are mounted on a main print substrate 108.

The CPU 101 performs overall control of the mouse apparatus 100. The wireless module 102 performs processing for establishing wireless communication with an information processing apparatus such as a PC (Personal Computer). The optical system assembly 103 detects a position of the mouse apparatus 100 to generate information on two-dimensional coordinates and supplies the information to the CPU 101. The battery portion 104 is a power supply source necessary for operating the mouse apparatus 100.

The cover-opening/closing operation detection switch 24 is a switch whose state is switched by the switch operation protrusion 33 of the base portion 30. Based on the state of the cover-opening/closing operation detection switch 24, power supply from the battery portion 104 to the main print substrate 108 is turned on/off. In other words, the cover-opening/closing operation detection switch 24 corresponds to a switch portion that turns off the power supply from the battery when the slide cover 60 is at the first position and turns on the power supply from the battery when the slide cover 60 is at least at the second position.

The right-button switch 21 is a switch that detects a press of the right button 12 of the key portion 11. The left-button switch 22 is a switch that detects a press of the left button 13 of the key portion 11. The encoder 105 detects a rotational amount of the scroll wheel 14. The pair ring button 106 is a button that receives a command to set an apparatus to be a communication pair with the mouse apparatus 100 from a user and notifies the CPU 101 to that effect.

In the structure described above, a power supply switch 107 constantly monitors an input of a detection signal from the cover-opening/closing operation detection switch 24. When it is assumed that the power supply from the battery portion 104 to the main print substrate 108 is currently turned off, the cover-opening/closing operation detection switch 24 at this time is in a first state by a bias force caused by means of a spring or the like. When the cover-opening/closing operation detection switch 24 is switched from the first state to a second state by an interference with the switch operation protrusion 33 of the base portion 30, the power supply from the battery portion 104 to the main print substrate 108 is switched on from off. As a result, the mouse apparatus 100 becomes operable. Moreover, when the cover-opening/closing operation detection switch 24 is switched to the first state due to a release of the interference with the switch operation protrusion 33 of the base portion 30, the power supply from the battery portion 104 to the main print substrate 108 is switched off from on.

(Insulation Structure of Slide Cover 60 and Base Portion 30 with Respect to Rail Portion 40)

Next, an insulation structure of the slide cover 60 and the base portion 30 with respect to the rail portion 40 will be described.

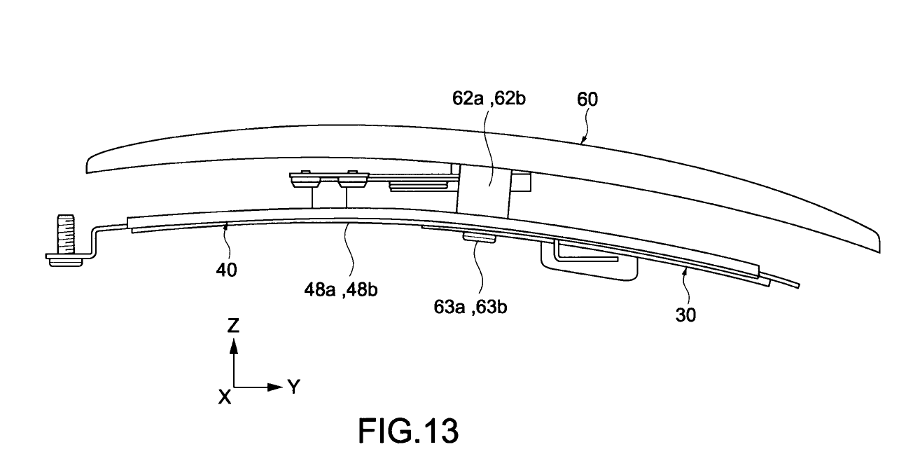

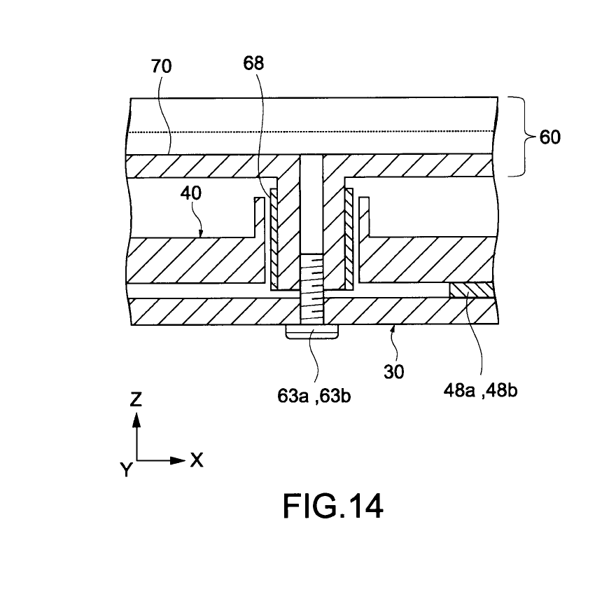

FIG. 13 is a side view showing a coupled state of the slide cover 60 and the base portion 30. FIG. 14 is a partially-enlarged cross-sectional diagram of FIG. 13. As shown in the figures, one end of each of the coupling shafts 62a and 62b is fixed to the slide cover 60, and the other ends are fixed to the screws 63a and 63b, respectively. A cylindrical resin component 68 is fit to an outer circumference of each of the coupling shafts 62a and 62b. Therefore, the coupling shafts 62a and 62b can prevent, while respectively engaging with the first guide groove 45a and the second guide groove 45b of the rail portion 40, an electrical contact from occurring at the engagement portions. Furthermore, for preventing an electrical contact between surfaces of the base portion 30 and the rail portion 40 opposing each other from occurring, the thin-plate-like resin components 48a and 48b are attached to the surface of the rail portion 40 on a side opposed to the base portion 30.

With this structure, an insulation property of the slide cover 60 and the base portion 30 with respect to the rail portion 40 can be improved, with the result that it becomes possible to prevent electrostatic breakdown of electronic components of the mouse body 10 from occurring due to a large current flowing to the electronic components from the charged rail portion 40 via the switch operation protrusion 33 of the base portion 30 and the cover-opening/closing operation detection switch 24.

### Second Embodiment

Next, a second embodiment of the present invention will be described.

A mouse apparatus of this embodiment is a mouse apparatus capable of being used while switching modes between a first mode in which the key portion 11 is used for inputting a mouse operation and a second mode in which the key portion 11 is used for an input for a specific purpose such as a presentation. Even when the same button of the key portion 11 is operated in the first mode and the second mode, different commands are transmitted from the mouse apparatus to an electronic apparatus as a communication counterpart. For example, when the mouse apparatus is used in a presentation, a command instructing to turn a page or the like is generated in the mouse apparatus with respect to an operation to the left button 13 and output thereafter. The mouse apparatus may alternatively be used as a remote controller in the second mode.

The mouse apparatus of this embodiment is capable of selectively switching the mode of the key portion 11 based on the position of the slide cover 60.

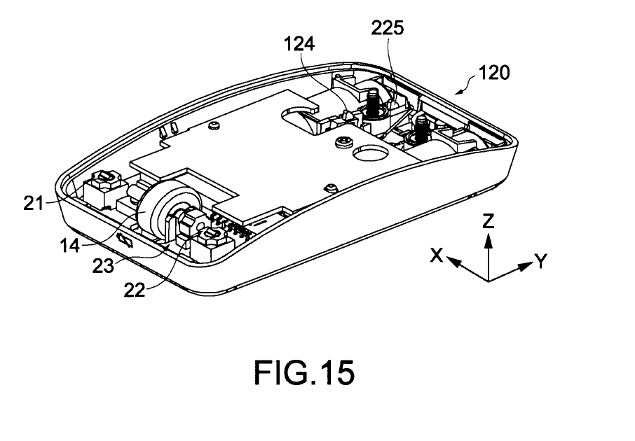

FIG. 15 is a perspective view showing a lower casing 120 of the mouse apparatus of this embodiment. As shown in the figure, the number of cover-opening/closing operation detection switches and positions thereof in the mouse apparatus of this embodiment are different from those of the first embodiment. Specifically, a first cover-opening/closing operation detection switch 124 and a second cover-opening/closing operation detection switch 225 are provided in the lower casing 120, and the switches 124 and 225 are provided apart from each other in the Y-axis direction with a predetermined distance provided therebetween. States of the switches 124 and 225 are switched by an interference with a switch operation protrusion 133 of the base portion 30.

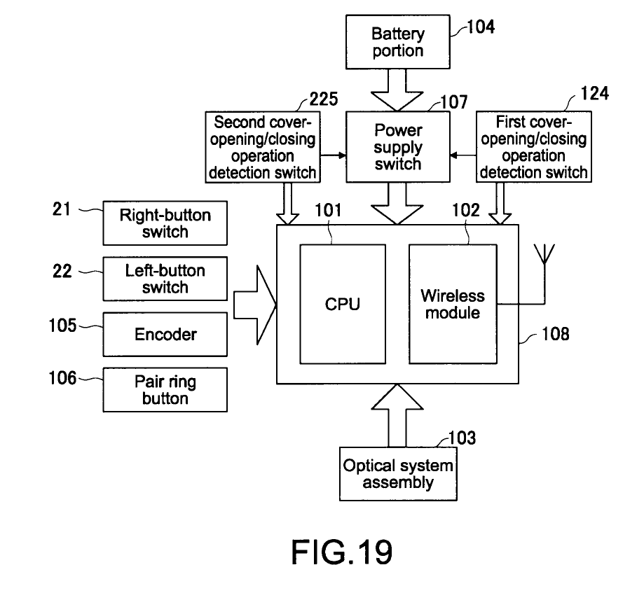

FIG. 19 is a block diagram showing an electrical structure of the mouse apparatus.

The first cover-opening/closing operation detection switch 124 and the second cover-opening/closing operation detection switch 225 are each structured to notify the power supply switch 107 and the CPU 101 of a detection signal corresponding to its own state. Other structures are the same as those of the first embodiment.

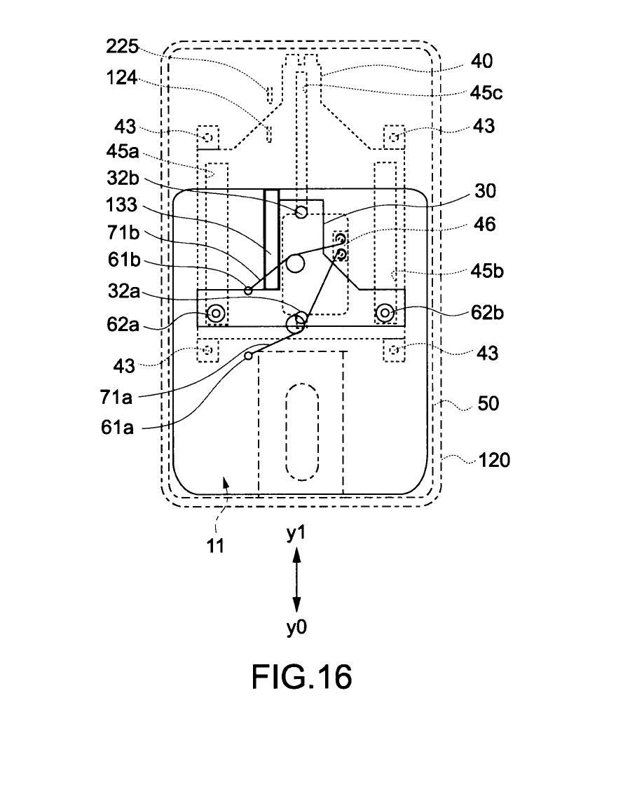

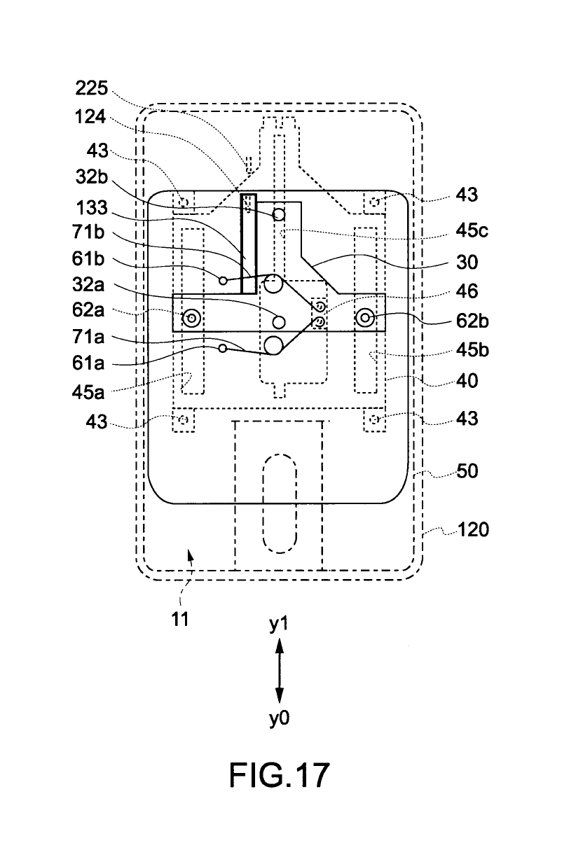

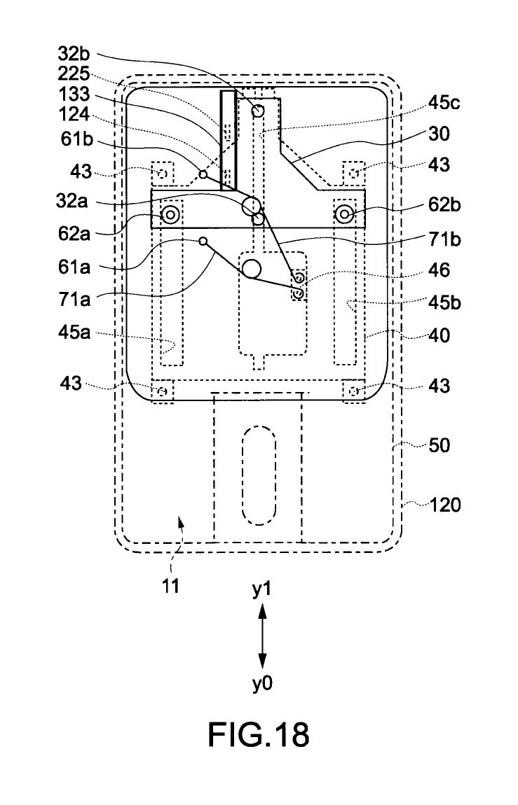

FIGS. 16 to 18 are diagrams each showing a relationship between the position of the slide cover 60 and the state of the switches. FIG. 16 is a plan view showing a state where the slide cover 60 is at the first position, FIG. 18 is a plan view showing a state where the slide cover 60 is at the second position, and FIG. 17 is a plan view showing a state where the slide cover 60 is at approximately the intermediate position between the first position and the second position. Here, the intermediate position between the first position and the second position may be an intermediate position strictly set based on a distance, or may be a position arbitrarily set between the first position and the second position. Hereinafter, those positions will collectively be referred to as “second intermediate position”. In addition, the second intermediate position may either be the same as or different from the intermediate position of the first embodiment. Moreover, in FIGS. 16 to 18, the upper casing 50, the rail portion 40, and the like that do not move with respect to the lower casing 120 at a time the slide cover 60 is slid are indicated by dashed lines or dotted lines, whereas the base portion 30 and the slide cover 60 that move with respect to the lower casing 120 at the time the slide cover 60 is slid are indicated by solid lines. Furthermore, since a mechanism for causing the slide cover 60 to slide and operations of the inverted springs 71a and 71b are the same as those of the first embodiment, descriptions thereof will be omitted. Thus, descriptions will be mainly given on operations of the first cover-opening/closing operation detection switch 124 and the second cover-opening/closing operation detection switch 225 accompanying the movement of the slide cover 60.

When a user applies a force to move the slide cover 60 in the y1 direction by an operation with a finger in the state shown in FIG. 16, the slide cover 60 and the base portion 30 move integrally from the first position toward the second intermediate position. When the slide cover 60 reaches the second intermediate position (FIG. 17), the switch operation protrusion 133 provided on the base portion 30 is brought into contact with the first cover-opening/closing operation detection switch 124 and presses it (FIG. 17). As a result, power of the mouse apparatus 100 is turned on.

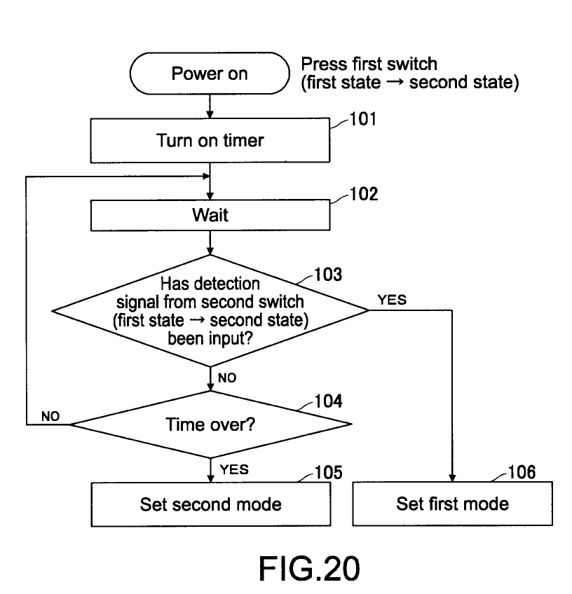

FIG. 20 is a flowchart showing a flow of processing of the CPU 101 that is started when the power of the mouse apparatus 100 is turned on. When power of the CPU 101 is turned on, the CPU 101 starts up the system in accordance with a basic program of the system. Right after the start-up of the system, the CPU 101 monitors an input from the second cover-opening/closing operation detection switch 225 for a predetermined time period in accordance with the basic program. Then, when a detection signal indicating that the state has been switched from the first state to the second state by an interference with the switch operation protrusion 133 is not input from the second cover-opening/closing operation detection switch 225 within a certain monitoring time period (YES in Step S104), the CPU 101 assumes that the user has intentionally stopped the slide of the slide cover 60 in the y1 direction near the second intermediate position and sets the second mode as the mode of the key portion 11 (Step S105). As a result, the mouse apparatus can be used in a presentation or as a remote controller for purposes other than a normal purpose.

Further, when a detection signal indicating that the state has been switched from the first state to the second state by an interference with the switch operation protrusion 133 is input from the second cover-opening/closing operation detection switch 225 within a certain monitoring time period (YES in Step S103), the CPU 101 carries out processing as follows. In this case, the CPU 101 assumes that the user has intentionally slid the slide cover 60 to the second position in the y1 direction as shown in FIG. 18 and sets the first mode as the mode of the key portion 11 (Step S106). As a result, the mouse apparatus can be used for a normal purpose.

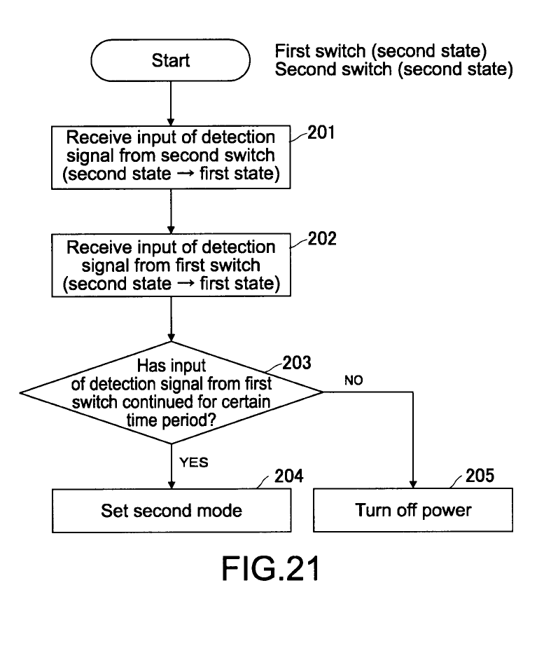

Next, an operation carried out at a time the slide cover 60 slides in a y0 direction from the second position will be described. FIG. 21 is a flowchart showing a flow of processing of the CPU 101 at this time.

In this case, a detection signal indicating that the state has been switched from the second state to the first state by an interference with the switch operation protrusion 133 is input to the CPU 101 from the second cover-opening/closing operation detection switch 225 (Step S201). Upon being input with the detection signal, the CPU 101 then monitors an input of a detection signal indicating that the state has been switched from the second state to the first state by a release of an interference with the switch operation protrusion 133 from the first cover-opening/closing operation detection switch 124. Upon confirming the input of the detection signal from the first cover-opening/closing operation detection switch 124 (Step S202), the CPU 101 judges whether the input of the detection signal is continued for a certain time period (Step S203). When the input of the detection signal from the first cover-opening/closing operation detection switch 124 is continued for a certain time period, the CPU 101 assumes that the user has intentionally stopped the slide of the slide cover 60 in the y0 direction near the second intermediate position and sets the second mode as the mode of the key portion 11 (Step S204). On the other hand, when the input of the detection signal from the first cover-opening/closing operation detection switch 124 is not continued for a certain time period, the CPU 101 assumes that the user has intentionally slid the slide cover 60 to the first position in the y0 direction and controls the power supply switch 107 to turn off the power (Step S205).

As described above, according to this embodiment, the mode of the key portion 11 can be switched with an operation to the slide cover 60, with the result that an operability of a mode switch is improved.

### Modified Example 1

Next, Modified Example 1 of the present invention will be described.

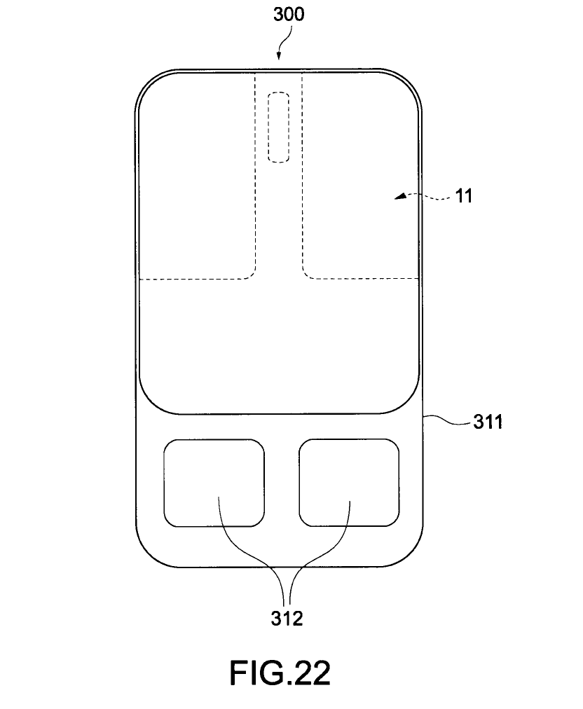

FIG. 22 is an upper plan view of a mouse apparatus 300 according to a modified example of the above embodiments. The mouse apparatus 300 of Modified Example 1 is different from the mouse apparatus 100 of the first embodiment in that a second key portion 312 that is exposed to be used by the user when the slide cover 60 is at the first position at which the key portion 11 is hidden is provided. The second key portion 312 is an operation portion that can be used in a presentation or as a remote controller for purposes other than a normal purpose of the mouse apparatus. Moreover, in the mouse apparatus 300, a power supply switch (not shown) is provided on, for example, a back surface of a mouse body 311 so as to enable the power to be turned on even when the slide cover 60 is at the first position.

### Modified Example 2

Next, Modified Example 2 of the present invention will be described.

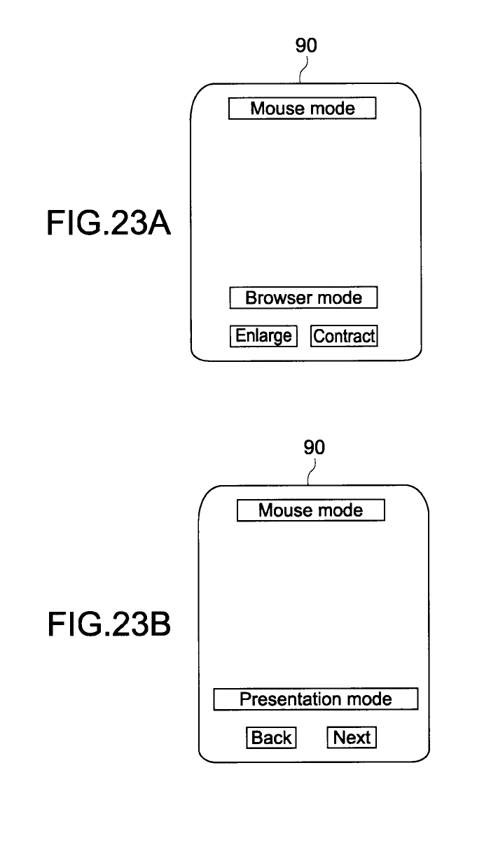

FIG. 23 are diagrams showing application examples of the cover body 90 of the mouse apparatus of the second embodiment.

The mouse apparatus of the second embodiment can be used while switching the mode of the key portion 11. In this regard, as a design of the cover body 90, a cover body on the surface of which operating instructions of the key portion that correspond to the respective modes are printed may be adopted. By attaching the cover body 90 corresponding to the mode used, the user can comfortably operate the mouse apparatus while checking the operating instructions printed on the cover body 90. It should be noted that FIG. 23A shows a design example of the operating instructions of the cover body 90 used when the mouse apparatus is used as a normal mouse, whereas FIG. 23B shows a design example of the operating instructions of the cover body 90 used when the mouse apparatus is used for a presentation.

### Modified Example 3

Next, Modified Example 3 of the present invention will be described.

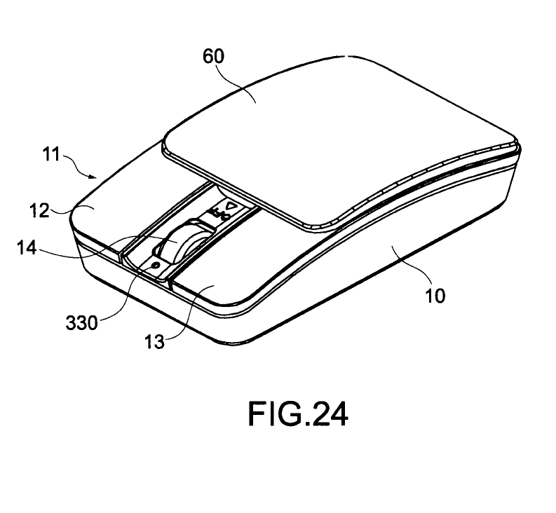

A mouse apparatus 400 of Modified Example 3 is a mouse apparatus in which, as shown in FIG. 24, a mode display portion 330 that visually displays a mode that is switched in accordance with the position to which the slide cover 60 is moved for the user to recognize the mode is provided in the vicinity of the key portion 11 in the mouse apparatus of the second embodiment. The mode display portion 330 is constituted of, for example, a light-emitting device such as an LED (Light Emitting Diode).

The present application contains subject matter related to that disclosed in Japanese Priority Patent Application JP 2009-142815 filed in the Japan Patent Office on Jun. 15, 2009, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A mouse apparatus, comprising:
a mouse body including a built-in battery;
at least one operation portion provided on the mouse body;
a slide cover that is movable with respect to the mouse body between a first position that disables an operation by blocking the operation portion and a second position that enables an operation to be made by exposing the operation portion; and
a switch portion to turn off power supply from the battery when the slide cover is at the first position and turn on the power supply from the battery when the slide cover is at least at the second position.

2. The mouse apparatus according to claim 1,
wherein a surface of the mouse body opposed to the slide cover is a curvature radius surface that sticks out upwardly, and
wherein the slide cover is constituted of a plate having a shape that is curved along the curvature radius surface of the mouse body.

3. The mouse apparatus according to claim 2,
wherein the slide cover includes
a cover body,
a cover base portion that is movably provided on the mouse body, and
an attachment portion that is fixed to the cover base portion and detachably attaches the cover body,
wherein the attachment portion includes a positioning portion that positions, while securing a certain amount of a relief portion in a first axis direction in which the slide cover is movable, the cover body in a second axis direction orthogonal to the first axis direction, and
wherein the cover base portion includes a fixing portion that fixes the cover body positioned at one end portion of the relief portion secured by the positioning portion of the attachment portion.

4. The mouse apparatus according to claim 3, further comprising
a bias means for biasing, when the slide cover is within a first range between a first intermediate position, that is a predetermined position between the first position and the second position, and the first position, the slide cover from the first intermediate position toward the first position, and biasing, when the slide cover is within a second range between the first intermediate position and the second position, the slide cover from the first intermediate position toward the second position.

5. The mouse apparatus according to claim 4,
wherein the switch portion turns on the power supply from the battery when the slide cover is within a range from the second position to a second intermediate position that is a predetermined position between the first position and the second position,
the mouse apparatus further comprising
a mode switch portion to switch an input mode at a time the slide cover is at the second position and a time the slide cover is at the second intermediate position.

6. The mouse apparatus according to claim 5, further comprising
a mode display portion to display a result of the switch of the input mode.
